(19) United States
(12) Patent Application Publication
(10) Pub. No.: US 2022/0339712 A1
(43) Pub. Date: Oct. 27, 2022

(54) TOOL ADAPTOR AND COMBINATION WITH TOOL

(71) Applicant: KOKUHIN METAL CO., LTD., Taichung City (TW)

(72) Inventor: SHIH KAI LIN, Taichung City (TW)

(21) Appl. No.: 17/580,856

(22) Filed: Jan. 21, 2022

(30) Foreign Application Priority Data
Apr. 27, 2021 (TW) 110115163

(51) Int. Cl. B23B 31/107

(52) U.S. Cl. CPC B23B 31/1071

(57) ABSTRACT

A tool adaptor includes a body, a sleeve slidably mounted around the body, an elastic member abutting against the body and the sleeve, and an engaging ball. The body has a connecting hole and an engaging hole. The sleeve has a pressing portion. The engaging ball is movably disposed in the engaging hole and selectively pressed by the pressing portion to enter the connecting hole and to engage with an engaging groove a tool. A size of the at least one engaging ball is configured such that when the at least one engaging ball enters the connecting hole, a clearance is formed between an outer periphery of the engaging ball and a groove bottom face of the engaging groove.

### BACKGROUND

The present invention relates to a tool adaptor and more particularly to a combination of a tool adaptor and a tool.

In order to connect various screw tools for use, most of the current conventional tool adaptors are provided with a fixing hole on a front edge of a chuck body for detachably connecting the screw tool, and a sliding sleeve slidable in relation to the chuck body to actuate a detent ball to selectively enter the fixing hole to engage with a groove of the screw tool, so as to detachably connect the screw tool to the fixing hole.

Therefore, the conventional tool adaptor only uses the engaging relationship between the detent ball and the groove of the screw tool to hold the screw tool not detached from the fixing hole. In other words, in order for the screw tool to be perfectly connected to the fixing hole, the structural design of the detent ball and the groove of the screw tool is very important. If the size of the detent ball is too small, it causes the detent ball to enter the fixing hole excessively, so that the screw tool will not be attached stably to the fixing hole.

### SUMMARY

An objective of the present invention is to provide a tool adaptor for stably connecting various tools having grooves.

In an aspect of the invention, a tool adaptor includes a body, a sleeve, an elastic member, and at least one engaging ball. The body defines a first end and a second end opposite to the first end along a longitudinal axis. The body is provided with a connecting hole extended along the longitudinal axis, and an engaging hole extended along a radial direction of the longitudinal axis. The connecting hole at least penetrates the first end and is adapted for connecting a tool having an engaging groove. The engaging hole communicates with the connecting hole. The sleeve is slidably mounted around the body along the longitudinal axis. The sleeve is provided with a pressing portion protruding from an inner side wall surface of the sleeve. The elastic member elastically abuts against the body and the sleeve. The at least one engaging ball is movably disposed in the engaging hole along the radial direction of the longitudinal axis. The at least one engaging ball is selectively pressed by the pressing portion as the sleeve slides relative to the body, so as to enter the connecting hole and to engage with the engaging groove of the tool. A size of the at least one engaging ball is configured such that when the at least one engaging ball enters the connecting hole, a clearance is formed between an outer periphery of the at least one engaging ball and a groove bottom face of the engaging groove.

In an example, the at least one engaging ball has a ball diameter not less than 6.5 mm.

In an example, the connecting hole has a hole diameter between 6.29 mm and 6.35 mm.

In an example, a ratio of a hole diameter of the connecting hole to a ball diameter of the at least one engaging ball is not greater than 0.98.

In an example, the connecting hole penetrates the first end and the second end along the longitudinal axis.

In an example, when the at least one engaging ball is pressed by the pressing portion to enter the connecting hole and to engage with the engaging groove of the tool, the outer periphery of the at least one engaging ball and the groove bottom face of the engaging groove forms at least two contact points. The clearance is defined by the outer periphery of the at least one engaging ball, the groove bottom face of the engaging groove, and the at least two contact points.

In an example, the at least one engaging ball includes two engaging balls respectively disposed at two opposite sides of the engaging hole and movable along the radial direction of the longitudinal axis.

In an example, the body is provided with an annular groove around the outer periphery of the first end, and a limiting member is engaged in the annular groove and selectively abutted against the sleeve.

In an example, the body is provided with a shoulder portion between the first end and the second end. Two opposite ends of the elastic member elastically abut against the shoulder portion and the pressing portion, respectively.

In another aspect of the invention, a combination includes of a tool adaptor and a tool. The tool adaptor includes a body, a sleeve, an elastic member, and at least one engaging ball. The body defines a first end and a second end opposite to the first end along a longitudinal axis. The body is provided with a connecting hole extended along the longitudinal axis, and an engaging hole extended along a radial direction of the longitudinal axis. The connecting hole at least penetrates the first end. The engaging hole communicates with the connecting hole. The sleeve is slidably mounted around the body along the longitudinal axis. The sleeve is provided with a pressing portion protruding from an inner side wall surface of the sleeve. The elastic member elastically abuts against the body and the sleeve. The at least one engaging ball is movably disposed in the engaging hole along the radial direction of the longitudinal axis. The tool is detachably connected to the connecting hole and has an engaging groove. The at least one engaging ball is selectively pressed by the pressing portion as the sleeve slides relative to the body, so as to enter the connecting hole and to engage with the engaging groove of the tool. A size of the at least one engaging ball is configured such that when the at least one engaging ball enters the connecting hole, a clearance is formed between an outer periphery of the at least one engaging ball and a groove bottom face of the engaging groove.

The present invention will become clearer in light of the following detailed description of illustrative embodiments of this invention described in connection with the drawings.

### BRIEF DESCRIPTION OF THE DRAWINGS

FIG. 1 is a perspective view of a tool adaptor of an embodiment according to the present invention.

FIG. 2 is an exploded, perspective view of the tool adaptor of FIG. 1.

FIG. 3 is a cross sectional view of the tool adaptor of FIG. 1 and shows a tool attached to the tool adaptor when a sleeve is in a locking position.

FIG. 4 is an enlarged view taken from the encircled region of FIG. 3.

FIG. 5 is another cross sectional view of the tool adaptor of FIG. 1 and shows the sleeve switched from the locking position to a releasing position, enabling the tool to detached from the tool adaptor.

### DETAILED DESCRIPTION

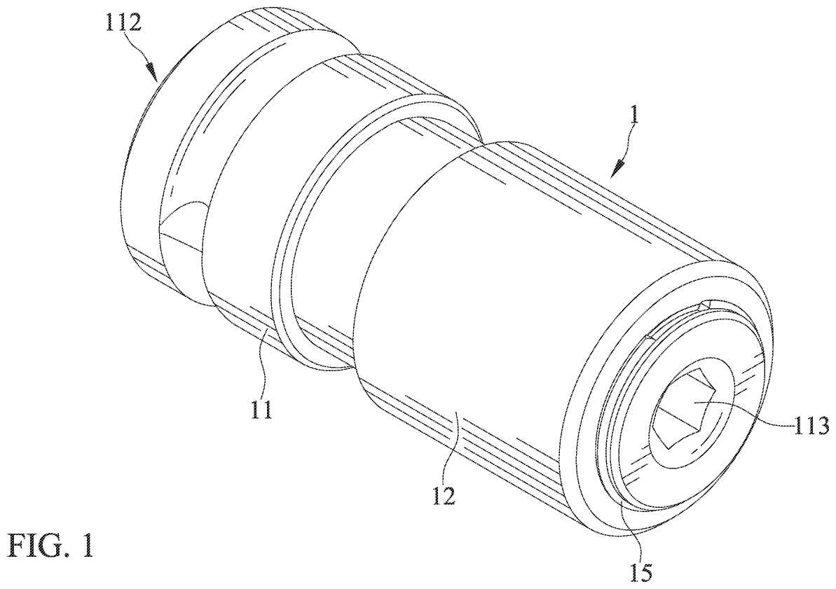

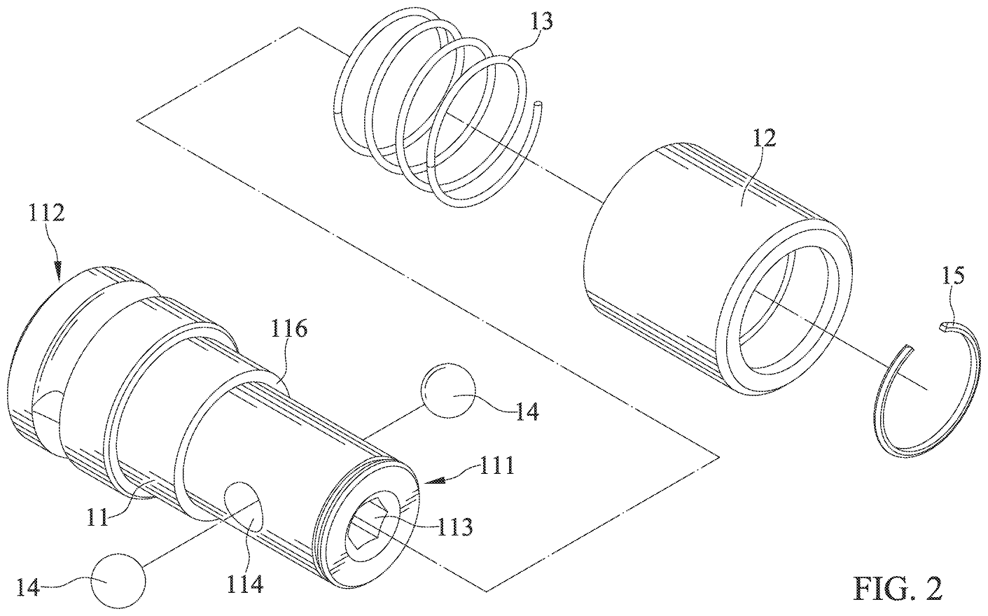

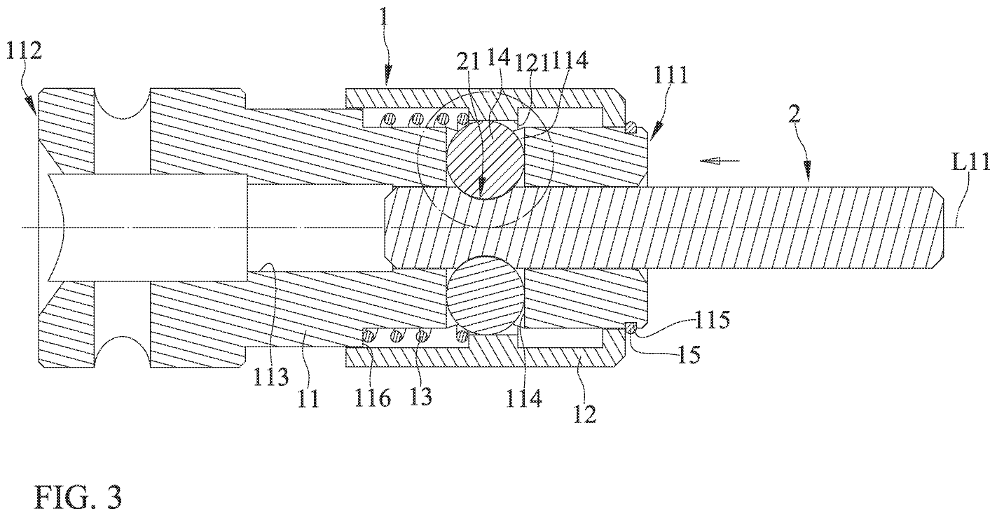

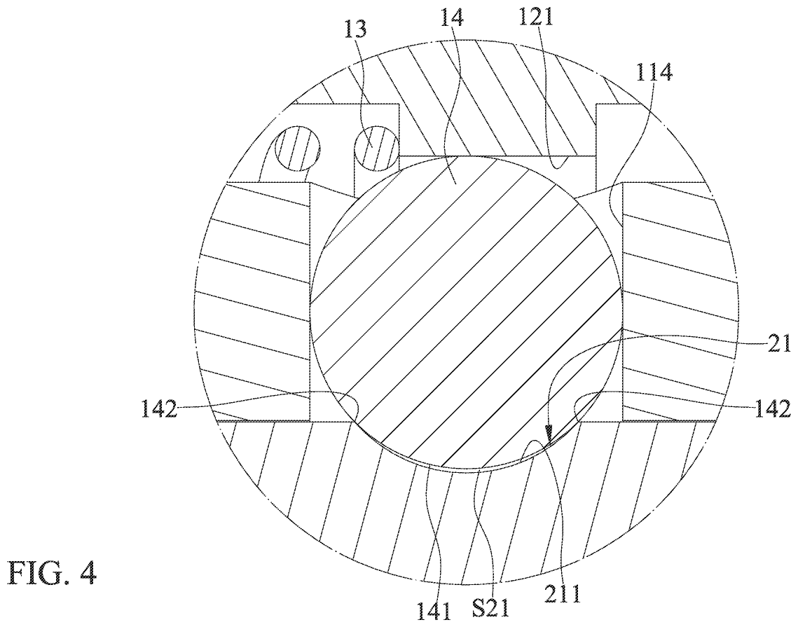

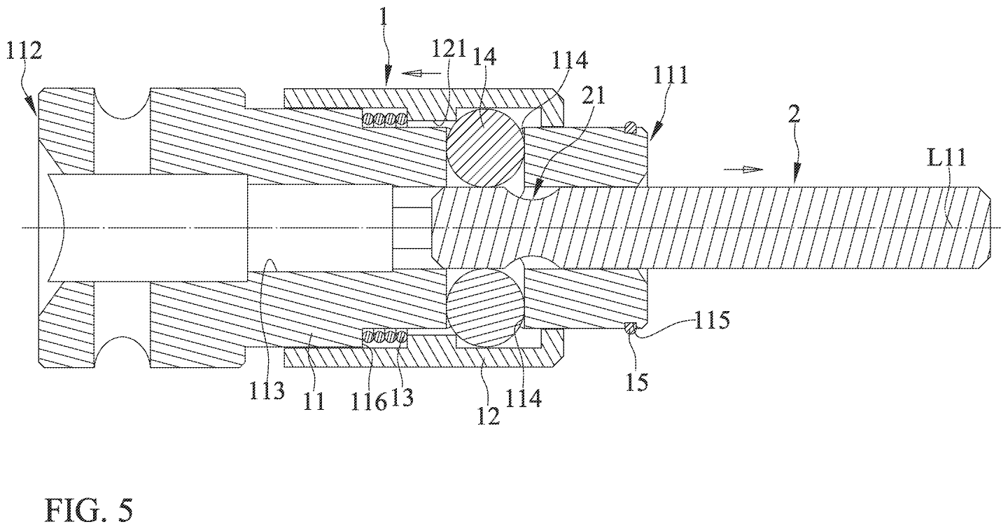

FIGS. 1-5 show a tool adaptor 1 of an embodiment according to the present invention. The tool adaptor 1 includes a body 11, a sleeve 12, an elastic member 13, and at least one engaging ball 14. The body 11 defines a first end 111 and a second end 112 opposite to the first end 111 along a longitudinal axis L11. The body 11 is provided with a connecting hole 113 extended along the longitudinal axis L11, and an engaging hole 114 extended along a radial direction of the longitudinal axis L11. The connecting hole 113 at least penetrates the first end 111 and is adapted for connecting a tool 2, which has an engaging groove 21. The engaging hole 114 communicates with the connecting hole 113. The sleeve 12 is slidably mounted around the body 11 along the longitudinal axis L11 to be switched between a locking position (FIG. 3) and a releasing position (FIG. 5). The sleeve 12 is provided with a pressing portion 121 protruding from an inner side wall surface of the sleeve 12. The elastic member 13 elastically abuts against the body 11 and the sleeve 12.

The at least one engaging ball 14 is movably disposed in the engaging hole 114 along the radial direction of the longitudinal axis L11. The at least one engaging ball 14 is selectively pressed by the pressing portion 121 as the sleeve 12 slides relative to the body 11, so as to enter the connecting hole 113 and to engage with the engaging groove 21 of the tool 2. A size of the at least one engaging ball 14 is configured such that when the at least one engaging ball 14 enters the connecting hole 113, a clearance S21 (shown in FIG. 3) is formed between an outer periphery 141 of the at least one engaging ball 14 and a groove bottom face 211 of the engaging groove 21.

In order to make a clearance S21 formed between the outer periphery 141 of the at least one engaging ball 14 and the groove bottom face 211 of the engaging groove 21, in the embodiment, the at least one engaging ball 14 has a ball diameter not less than 6.5 mm, and the connecting hole 113 has a hole diameter between 6.29 mm and 6.35 mm, and a ratio of a hole diameter of the connecting hole 113 to a ball diameter of the at least one engaging ball 14 is not greater than 0.98.

Further, the connecting hole 113 can penetrate the first end 111 and the second end 112 along the longitudinal axis L11, so that the connecting hole 113 can be suitable for connecting tools 2 with different lengths, even if the length of the tool 2 is greater than that of the tool adaptor 1. The tool 2 can pass through the connecting hole 113 penetrating the first end 111 and the second end 112 and to be connected with the tool adaptor 1.

In the embodiment, the at least one engaging ball 14 may include two engaging balls 14 respectively disposed at two opposite sides of the engaging hole 114 and movable along the radial direction of the longitudinal axis L11 to detachably engage with the engaging groove 21 of the tool 2. The body 11 is provided with an annular groove 115 around the outer periphery of the first end 111, and a limiting member 15 is engaged in the annular groove 115 and selectively abutted against the sleeve 12 to prevent the sleeve 12 detached from the body 11. The body 11 is provided with a shoulder portion 116 between the first end 111 and the second end 112, and two opposite ends of the elastic member 13 elastically abut against the shoulder portion 116 and the pressing portion 121, respectively to bias the sleeve 12 toward the limiting member 15.

When the sleeve 12 is in the locking position (FIG. 3), the sleeve 12 is limited by the limiting member 15, and the pressing portion 121 of the sleeve 12 presses against the engaging ball 14 so that the engaging ball 14 enters the connecting hole 113 and engages with the engaging groove 21 of the tool 2. Further, when the engaging ball 14 enters the connecting hole 113 and engages with the engaging groove 21 of the tool 2, the outer periphery 141 of the engaging ball 14 and the groove bottom face 211 of the engaging groove 21 forms at least two contact points 142, and the clearance S21 is defined by the outer periphery 141 of the engaging ball 14, the groove bottom face 211 of the engaging groove 21, and the at least two contact points 142.

A user can apply force to the sleeve 12, so that the sleeve 12 slides relative to the body 11 to switch from the locking position to the releasing position (FIG. 5). When the sleeve 12 is in the releasing position, the sleeve 12 is separated from the limiting member 15 and slides toward the second end 112 , the elastic member 13 is compressed by the pressing portion 121, and the engaging ball 14 is not pressed by the pressing portion 121 of the sleeve 12 to leave the connecting hole 113 to abut against an outer edge of the tool 2, so that the tool 2 can be detached from the connecting hole 113.

Therefore, the size of the engaging ball 14 is configured such that when the engaging ball 14 enters the connecting hole 113, the clearance S21 is formed between the outer periphery 141 of the engaging ball 14 and the groove bottom face 211 of the engaging groove 21 to prevent the engaging ball 14 to enter the connecting hole 113 excessively and to provide a good connection relationship with the engaging groove 21 of the tool 2.

Although specific embodiments have been illustrated and described, numerous modifications and variations are still possible without departing from the scope of the invention. The scope of the invention is limited by the accompanying claims.

1. A tool adaptor comprising:
a body defining a first end and a second end opposite to the first end along a longitudinal axis, wherein the body is provided with a connecting hole extended along the longitudinal axis, and an engaging hole extended along a radial direction of the longitudinal axis, wherein the connecting hole at least penetrates the first end and is adapted for connecting a tool having an engaging groove, and wherein the engaging hole communicates with the connecting hole;
a sleeve slidably mounted around the body along the longitudinal axis, wherein the sleeve is provided with a pressing portion protruding from an inner side wall surface of the sleeve;
an elastic member elastically abutting against the body and the sleeve; and
at least one engaging ball movably disposed in the engaging hole along the radial direction of the longitudinal axis, wherein the at least one engaging ball is selectively pressed by the pressing portion as the sleeve slides relative to the body, so as to enter the connecting hole and to engage with the engaging groove of the tool;
wherein a size of the at least one engaging ball is configured such that when the at least one engaging ball enters the connecting hole, a clearance is formed between an outer periphery of the at least one engaging ball and a groove bottom face of the engaging groove.

2. The tool adaptor as claimed in claim 1, wherein the at least one engaging ball has a ball diameter not less than 6.5 mm.

3. The tool adaptor as claimed in claim 1, wherein the connecting hole has a hole diameter between 6.29 mm and 6.35 mm.

4. The tool adaptor as claimed in claim 1, wherein a ratio of a hole diameter of the connecting hole to a ball diameter of the at least one engaging ball is not greater than 0.98.

5. The tool adaptor as claimed in claim 1, wherein the connecting hole penetrates the first end and the second end along the longitudinal axis.

6. The tool adaptor as claimed in claim 1, wherein when the at least one engaging ball is pressed by the pressing portion to enter the connecting hole and to engage with the engaging groove of the tool, the outer periphery of the at least one engaging ball and the groove bottom face of the engaging groove forms at least two contact points, and wherein the clearance is defined by the outer periphery of the at least one engaging ball, the groove bottom face of the engaging groove, and the at least two contact points.

7. The tool adaptor as claimed in claim 1, wherein the at least one engaging ball includes two engaging balls respectively disposed at two opposite sides of the engaging hole and movable along the radial direction of the longitudinal axis.

8. The tool adaptor as claimed in claim 1, wherein the body is provided with an annular groove around the outer periphery of the first end, and wherein a limiting member is engaged in the annular groove and selectively abutted against the sleeve.

9. The tool adaptor as claimed in claim 1, wherein the body is provided with a shoulder portion between the first end and the second end, and wherein two opposite ends of the elastic member elastically abut against the shoulder portion and the pressing portion, respectively.

10. A combination of a tool adaptor and a tool comprising:
the tool adaptor comprising:
a body defining a first end and a second end opposite to the first end along a longitudinal axis, wherein the body is provided with a connecting hole extended along the longitudinal axis, and an engaging hole extended along a radial direction of the longitudinal axis, wherein the connecting hole at least penetrates the first end, and wherein the engaging hole communicates with the connecting hole;
a sleeve slidably mounted around the body along the longitudinal axis, wherein the sleeve is provided with a pressing portion protruding from an inner side wall surface of the sleeve;
an elastic member elastically abutting against the body and the sleeve;
at least one engaging ball movably disposed in the engaging hole along the radial direction of the longitudinal axis; and
the tool detachably connected to the connecting hole and having an engaging groove;
wherein the at least one engaging ball is selectively pressed by the pressing portion as the sleeve slides relative to the body, so as to enter the connecting hole and to engage with the engaging groove of the tool;
wherein a size of the at least one engaging ball is configured such that when the at least one engaging ball enters the connecting hole, a clearance is formed between an outer periphery of the at least one engaging ball and a groove bottom face of the engaging groove.
